(19) United States
(12) Patent Application Publication
(10) Pub. No.: US 2015/0253231 A1
(43) Pub. Date: Sep. 10, 2015

(54) METHOD AND APPARATUS FOR IMPROVING TEMPERATURE MEASUREMENT IN A DENSITY SENSOR

(71) Applicant: HALLIBURTON ENERGY SERVICES INC., Houston, TX (US)

(72) Inventors: Li Gao, Katy, TX (US); Wei Zhang, Houston, TX (US); David P. Perkins, The Woodlands, TX (US); Dingding Chen, Plano, TX (US); Nestor Rodriquez, Shenandoah, TX (US)

(21) Appl. No.: 14/432,152

(22) PCT Filed: Dec. 6, 2012
(86) PCT No.: PCT/US2012/068189

§ 371 Date: Mar. 27, 2015

(51) Int. Cl. G01N 9/00; G01N 9/32

(52) U.S. Cl. CPC G01N 9/002; G01N 9/32; G01N 2009/006

(57) ABSTRACT

An apparatus for determining the density of a fluid in a flowstream is disclosed. The apparatus comprises a vibrating tube (12) having a bore and a vibrating region. The apparatus also comprises a housing (16) to support the vibrating region. The apparatus further comprises a vibration source (22) and a vibration detector (24) coupled to the vibrating tube (12), and one or more sensors (26) coupled to the housing (16), said one or more sensors substantially oriented toward the vibrating region of the vibrating tube.

### BACKGROUND

There are many instances in industrial processes and controls for handling flowing fluids where it may be desirable to accurately determine the density of the moving fluid. One particular application relates to identification of reservoir fluids flowing in a well.

For instance, in certain applications, fluid density may be determined using a vibratory resonant densitometer in a certain environment. A vibratory resonant densitometer typically includes a tubular sample cavity (sometimes referred to as a “vibrating tube”) and other densitometer parts. Vibrating tube densitometers are highly sensitive to the temperature of the vibrating tube. This is due to the fact that the resonance frequency of the vibrating section depends critically on the Young's modulus of the vibrating tube material, which is a function of the vibrating tube temperature.

Typical vibrating tube densitometers may utilize temperature sensors coupled directly to a vibrating region of the vibrating tube. However, such coupling disturbs the resonance frequency of the vibrating tube and reduces the sensitivity of the sensor to density. In addition, coupling a temperature sensor directly to the vibrating tube leads to difficulty in the manufacturing processes. For these reasons, it is highly desirable not to couple any temperature sensors directly to the vibrating tube.

Some vibrating tube densitometers utilize temperature sensors coupled to the vibrating tube, but located on sections outside of the vibrating region. For instance, a vibrating tube densitometer may utilize two resistance temperature detectors (“RTD”) located outside the vibrating region. In this configuration, the vibrating tube temperature is determined by averaging the two RTD readings. This arrangement, however, may lead to errors in tube temperature measurements and thus, errors in density readings. For example, during field testing operations, if the fluid flow rate is low or zero, such as when pumping is stopped, significant temperature gradients may exist between the RTD locations and the center of the vibrating region of the vibrating tube.

### BRIEF DESCRIPTION OF THE DRAWINGS

Some specific exemplary embodiments of the disclosure may be understood by referring, in part, to the following description and the accompanying drawings.

FIG. 1 illustrates a cross-sectional view of a vibrating tube densitometer in accordance with certain embodiments of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and are not exhaustive of the scope of the disclosure.

### DETAILED DESCRIPTION OF THE DRAWINGS

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to horizontal, vertical, deviated, or otherwise nonlinear wellbores in any type of subterranean formation. Embodiments may be applicable to injection wells as well as production wells, including hydrocarbon wells.

The terms “couple,” “coupled,” or “couples” as used herein are intended to mean either an indirect or direct connection. Thus, if a first device couples to a second device, that connection may be through a direct connection, or through an indirect mechanical or electrical connection via other devices and connections. The term “uphole” as used herein means along the drillstring or the hole from the distal end towards the surface, and “downhole” as used herein means along the drillstring or the hole from the surface towards the distal end.

The present disclosure relates generally to devices and methods for measuring fluid density and other fluid flow properties in a flow stream, and more particularly, in certain embodiments, to an improved method of measuring temperature in a vibrating tube density sensor.

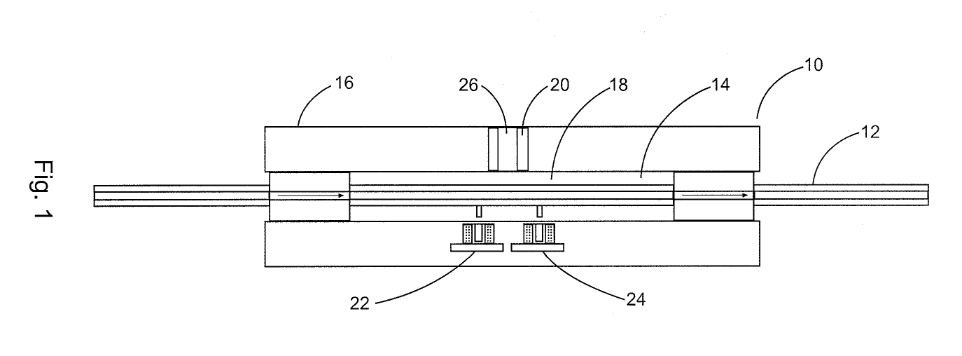

Referring to FIG. 1, an apparatus for determining the density of a fluid in a flowstream in accordance with an illustrative embodiment of the present disclosure may include a vibrating tube densitometer 10. The vibrating tube densitometer 10 may include a vibrating tube 12 having a bore therethrough. The vibrating tube 12 may be straight, U-shaped, or in any other suitable shape known to those of ordinary skill in the art, having the benefit of the present disclosure. The vibrating tube 12 may also include a vibrating region 14. The vibrating tube densitometer 10 may further include a housing 16 to support the vibrating region 14. In certain illustrative embodiments, the housing 16 may enclose the vibrating region 14, and an annular area 18 may be formed between the vibrating tube 12 and the housing 16. While the illustrative embodiment shows the housing 16 fully enclosing the vibrating region 14 of the vibrating tube 12, one of ordinary skill in the art would appreciate that other configurations are possible in accordance with the present disclosure. In certain embodiments, the housing 16 may include one or more slots 20. FIG. 1 shows only one slot 20 in the housing 16. However, those skilled in the art will appreciate that the present disclosure is not limited to a housing 16 with only one slot 20. Specifically, other suitable configurations of the housing 16 with more than one slot 20 may be used without departing from the scope of the present disclosure.

In certain embodiments in accordance with the present disclosure, the vibrating tube densitometer 10 may include a vibration source 22 and a vibration detector 24 coupled to the vibrating tube 12. There are various ways to excite vibration in the vibrating tube 12, as would be appreciated by those of ordinary skill in the art, having the benefit of this disclosure. In certain embodiments, the vibration source 22 may be a driver coil. In other embodiments, the vibration source 22 may be an electromagnetic hammer used to strike the vibrating tube 12. In other embodiments, the vibration source 22 may be a magnetic field, in which case the vibrating tube 12 may be placed in the presence of the magnetic field and alternating currents may be passed through the vibrating tube 12 to cause vibrations. There are also various ways to detect vibration in the vibrating tube 12, as would be appreciated by those of ordinary skill in the art, having the benefit of this disclosure. In certain embodiments, the vibration detector 24 may be a detector coil. In other embodiments, the vibration detector 24 may be an optical sensor and the vibration may be detected by detecting light reflected off the vibrating tube 12. In other embodiments, the vibration detector 24 may be an accelerometer and the vibration may be detected by measuring the response of the accelerometer attached to the vibrating tube 12. In other embodiments, the vibration detector 24 may be a displacement sensor, a strain gauge, or a microphone used to detect the sound generated by the vibrating tube 12.

In certain embodiments in accordance with the present disclosure, the vibrating tube 12 may be operable to receive a sample fluid. The sample fluid may comprise one or a combination of a liquid, a solid, or a gas.

In certain embodiments in accordance with this disclosure, and as shown in FIG. 1, one or more sensors 26 may be coupled to the housing 16. The one or more sensors 26 may be substantially oriented toward the vibrating region 14 of the vibrating tube 12. Any suitable sensors may be used. For instance, in certain implementations, the sensors 26 may be infrared thermopile sensors or other optical radiation transducers, including, but not limited to, thermal transducers such as pyroelectric sensors, thermistors, and themophiles; photodiodes, such as silicon (Si); or photconductors, such as lead sulfide (PbS) and lead selenide (PbSe). Infrared thermopile sensors measure the infrared heat of an object, which then reflects the temperature of that object. Certain photodiodes may be sensitive to different infrared wavelength ranges and thus the output of the photodiode may directly correlate with the temperature of an object. In certain embodiments, the sensors 26 may be disposed within the one or more slots 20 in the housing 16, and adjacent the annular area 18 between the vibrating tube 12 and the housing 16. The one or more sensors 26 may be operable to measure a temperature of the vibrating tube 12 without contacting the vibrating tube 12. In certain embodiments in accordance with an illustrative embodiment, only one sensor 26 may be utilized. The sensor 26 may be located opposite the center of the vibrating region 14. In certain other embodiments in accordance with the present disclosure, two or more sensors 26 may be located along a length of the housing 16 opposite a length of the vibrating region 14. The two or more sensors 26 may be operable to measure a temperature gradient of the vibrating tube 12 along the vibrating region 14. Information on the temperature gradient across the vibrating tube 12 may lead to enhancement in accuracy of temperature measurements, and in turn, density measurements as discussed below.

As would be appreciated by those of ordinary skill in the art having the benefit of this disclosure, the sensors 26 may be utilized to measure the temperature of the vibrating tube 12 without contacting the vibrating tube 12. Because any additional loading on the vibrating tube 12 may change the resonance frequency of the vibrating tube 12 and adversely affect the sensitivity of the vibrating tube 12 to density measurements, the sensors 26 do not contact the vibrating tube 12 and, therefore, do not disturb the resonance frequency of the vibrating tube 12 and the vibration signal generated from the vibrating tube 12. As a result, the sensors 26 may be utilized to reduce the risk of error in temperature measurement and improve the accuracy of density measurement of fluids.

As would be appreciated by those of ordinary skill in the art having the benefit of this disclosure, the density of a fluid in a flowstream may be determined using the vibrating tube densitometer 10. In certain embodiments, a plurality of parameters characterizing the environment of the vibrating tube 12 may be measured. These measured parameters may include any desirable parameters, including, but not limited to, a temperature of the vibrating tube 12. Other parameters may be measured and may be necessary for determining density, but measurement of the temperature of the vibrating tube 12 is the object of the present disclosure. A sample fluid may be received into the vibrating tube 12. The vibrating tube 12 may then be vibrated to obtain a vibration signal corresponding to the sample fluid in the vibrating tube 12. The density of the sample fluid may be determined using, in part, the measured temperature of the vibrating tube. Density of the sample fluid may be determined by any formula known to those of ordinary skill in the art, utilizing the measured temperature of the vibrating tube. With the improved temperature measurement obtained by virtue of the techniques disclosed herein, the density of the sample fluid may be more accurately determined.

Accordingly, an apparatus and method for improving the accuracy of temperature measurement of the vibrating tube 12 in a vibrating tube densitometer 10 is disclosed. One or more sensors 26 are utilized to directly measure the temperature of the vibrating region 14 of the vibrating tube 12. In this manner, embodiment of the present disclosure may achieve enhanced accuracy in temperature measurements via a non-contact means, which may lead to enhanced accuracy in the determination of formation fluid density downhole.

Therefore, embodiments of the present disclosure are well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. For example, many of the features could be moved to different locations on respective parts. Furthermore, no limitations are intended to be limited to the details of construction or design herein shown, other than as described in the claims below. It is therefore evident that the particular illustrative embodiments disclosed above may be altered or modified and all such variations are considered within the scope and spirit of the present disclosure. Moreover, the indefinite articles “a” or “an,” as used in the claims, are defined herein to mean one or more than one of the elements that it introduces. Also, the terms in the claims have their plain, ordinary meaning unless otherwise explicitly and clearly defined by the patentee.

What is claimed is:

1. An apparatus for determining density of a fluid in a flowstream comprising:
a vibrating tube having a bore and a vibrating region;
a housing to support the vibrating region;
a vibration source coupled to the vibrating tube;
a vibration detector coupled to the vibrating tube; and
one or more sensors coupled to the housing, said one or more sensors substantially oriented toward the vibrating region of the vibrating tube.

2. The apparatus of claim 1, wherein the housing encloses the vibrating region of the vibrating tube and forms an annular area between the vibrating region of the vibrating tube and the housing.

3. The apparatus of claim 1, wherein the housing comprises one or more slots, and wherein the one or more sensors are disposed within the one or more slots in the housing, and adjacent an annular area between the vibrating region of the vibrating tube and the housing.

4. The apparatus of claim 1, wherein the vibration source is at least one of a driver coil, an electromagnetic hammer, or a magnetic field.

5. The apparatus of claim 1, wherein the vibration detector is at least one of a detector coil, an optical sensor, an accelerometer, a displacement sensor, a strain gauge, or a microphone.

6. The apparatus of claim 1, wherein the vibrating tube is operable to receive a sample fluid having a density, and wherein the sample fluid comprises one or a combination of a liquid, a solid, or a gas.

7. The apparatus of claim 1, wherein the one or more sensors are operable to measure a temperature of the vibrating tube without contacting the vibrating tube.

8. The apparatus of claim 1, wherein the one or more sensors comprises one sensor located opposite the center of the vibrating region.

9. The apparatus of claim 1, wherein the one or more sensors comprises two sensors located along a length of the housing opposite a length of the vibrating region, and wherein the two sensors are operable to measure a temperature gradient of the vibrating tube along the vibrating region.

10. A method for determining density of a fluid in a flowstream using a vibrating tube densitometer comprising the steps of:
providing a vibrating tube densitometer comprising:
a vibrating tube having a bore and a vibrating region;
a housing to support the vibrating region;
a vibration source coupled to the vibrating tube; and
a vibration detector coupled to the vibrating tube;
providing one or more sensors coupled to the housing, said one or more sensors substantially oriented toward the vibrating region of the vibrating tube.

11. The method of claim 10, wherein the housing encloses the vibrating region of the vibrating tube and forms an annular area between the vibrating region of the vibrating tube and the housing.

12. The method of claim 10, wherein the housing comprises one or more slots, and wherein the one or more sensors are disposed within the one or more slots in the housing, and adjacent an annular area between the vibrating region of the vibrating tube and the housing.

13. The method of claim 10, wherein the vibration source is at least one of a driver coil, an electromagnetic hammer, or a magnetic field.

14. The method of claim 10, wherein the vibration detector is at least one of a detector coil, an optical sensor, an accelerometer, a displacement sensor, a strain gauge, or a microphone.

15. The method of claim 10, wherein the vibrating tube is operable to receive a sample fluid having a density, and wherein the sample fluid comprises one or a combination of a liquid, a solid, or a gas.

16. The method of claim 10, wherein the one or more sensors are operable to measure a temperature of the vibrating tube without contacting the vibrating tube.

17. The method of claim 10, wherein the one or more sensors comprises one sensor located opposite the center of the vibrating region.

18. The method of claim 10, wherein the one or more sensors comprises two sensors located along a length of the housing opposite a length of the vibrating region and wherein the two sensors are operable to measure a temperature gradient of the vibrating tube along the vibrating region.

19. A method for determining density of a fluid in a flowstream using a vibrating tube densitometer comprising the steps of:
providing a vibrating tube densitometer comprising:
a vibrating tube having a bore and a vibrating region;
a housing to support the vibrating region;
a vibration source coupled to the vibrating tube; and
a vibration detector coupled to the vibrating tube;
providing one or more sensors coupled to the housing, said one or more sensors substantially oriented toward the vibrating region of the vibrating tube; and
measuring a plurality of parameters of the vibrating tube, the plurality of parameters comprising a temperature of the vibrating tube.

20. The method of claim 19, further comprising the steps of receiving a sample fluid into the vibrating tube, vibrating the vibrating tube to obtain a vibration signal, and calculating the density of the sample fluid using the measured temperature of the vibrating tube.
